(19) United States
(12) Patent Application Publication
(10) Pub. No.: US 2025/0211829 A1
(43) Pub. Date: Jun. 26, 2025

(54) CONTINUATION OF CONTENT SERVICES IN THE EVENT OF SIGNAL LOSS

(71) Applicant: DISH Network L.L.C., Englewood, CO (US)

(72) Inventors: Yunfeng Yang, Aurora, CO (US); John Barbieri, Littleton, CO (US)

(21) Appl. No.: 18/396,039

(22) Filed: Dec. 26, 2023

(51) Int. Cl. H04N 21/647; G01W 1/10; H04N 21/61

(52) U.S. Cl. CPC H04N 21/64738; G01W 1/10; H04N 21/6143

(57) ABSTRACT

System, methods, and non-transitory, machine-readable media may facilitate continuation of content services in an event of signal loss. Electronic communications received via interfaces may be detected. An indication of a potential signal loss at a content receiver at a future time may be detected from the electronic communications. Consequent to the detecting the indication of the potential signal loss, the content receiver may be caused to configure to respond to a signal loss when the signal loss disrupts causing presentation of content by the content receiver. The content receiver may be configured to respond to the signal loss by causing presentation of user-selectable interface elements corresponding to content alternatives. Consequent to a selection of at least one user-selectable interface element, the content receiver may obtain at least one of the content alternatives, and the content receiver may output for presentation the at least one of the content alternatives.

This disclosure generally relates to content corresponding to televised and streamed events, and more particularly to continuation of content services in the event of signal loss.

### BACKGROUND

Data delivery via satellite can suffer from outages due to various adverse conditions. For example, adverse weather, such as heavy rain, can disrupt data delivery and compromise reliability of data delivery. Accordingly, a signal disruption may be caused by a weather condition. The disruption may last only for a short time in certain cases; in other cases, the disruption may last for up to a day or more, for example, due to major snowstorms. All disruptions, whether short or extended, can be undesirable to viewers who may simply see a signal-loss screen on their displays during the disruptions. Viewers are in need of better viewer experiences and interactive features.

Thus, there is a need for systems, methods, and processor-readable media that address the foregoing problems. This and other needs are addressed by the present disclosure.

### BRIEF SUMMARY

Certain embodiments according to the present disclosure relate generally to content corresponding to televised and streamed events, and more particularly to continuation of content services in the event of signal loss.

In one aspect, a system may facilitate continuation of content services in an event of signal loss. The system may include one or more processing devices and memory communicatively coupled with, and readable by, the one or more processing devices and having stored therein processor-readable instructions which, when executed by the one or more processing devices, cause the one or more processing devices to perform operations. The operations may include one or a combination of the following. A set of one or more electronic communications received via one or more interfaces may be detected. An indication of a potential signal loss at a content receiver at a future time may be detected from the set of one or more electronic communications. Consequent to the detecting the indication of the potential signal loss, the content receiver may be caused to configure to respond to a signal loss when the signal loss disrupts causing presentation of content by the content receiver. The content receiver may be configured to respond to the signal loss at least in part by causing presentation of one or more user-selectable interface elements corresponding to one or more content alternatives. Consequent to a selection of at least one user-selectable interface element of the one or more user-selectable interface elements, the content receiver may obtain at least part of at least one of the one or more content alternatives, and the content receiver may output for presentation the at least part of the at least one of the one or more content alternatives.

In another aspect, a method may facilitate continuation of content services in an event of signal loss. The method may include one or a combination of the following. A set of one or more electronic communications received via one or more interfaces may be detected. An indication of a potential signal loss at a content receiver at a future time may be detected from the set of one or more electronic communications. Consequent to the detecting the indication of the potential signal loss, the content receiver may be caused to configure to respond to a signal loss when the signal loss disrupts causing presentation of content by the content receiver. The content receiver may be configured to respond to the signal loss at least in part by causing presentation of one or more user-selectable interface elements corresponding to one or more content alternatives. Consequent to a selection of at least one user-selectable interface element of the one or more user-selectable interface elements, the content receiver may obtain at least part of at least one of the one or more content alternatives, and the content receiver may output for presentation the at least part of the at least one of the one or more content alternatives.

In yet another aspect, one or more non-transitory, machine-readable media may have machine-readable instructions thereon which, when executed by one or more processing devices, cause the one or more processing devices to perform one or a combination of the following. A set of one or more electronic communications received via one or more interfaces may be detected. An indication of a potential signal loss at a content receiver at a future time may be detected from the set of one or more electronic communications. Consequent to the detecting the indication of the potential signal loss, the content receiver may be caused to configure to respond to a signal loss when the signal loss disrupts causing presentation of content by the content receiver. The content receiver may be configured to respond to the signal loss at least in part by causing presentation of one or more user-selectable interface elements corresponding to one or more content alternatives. Consequent to a selection of at least one user-selectable interface element of the one or more user-selectable interface elements, the content receiver may obtain at least part of at least one of the one or more content alternatives, and the content receiver may output for presentation the at least part of the at least one of the one or more content alternatives.

In various embodiments, the detecting the indication of the potential signal loss may be based at least in part on forecasted weather conditions for a location corresponding to the content receiver. In various embodiments, wherein the potential signal loss may correspond to a potential loss of a satellite signal at the content receiver. In various embodiments, the detecting may include obtaining weather data from the set of one or more electronic communications and determining the potential signal loss based at least in part on analyzing the weather data for one or more one or more locations and mapping the one or more locations to the content receiver. In various embodiments, the detecting may include obtaining outage data for a plurality of content receivers from the set of one or more electronic communications and determining the potential signal loss based at least in part on analyzing the outage data for one or more one or more locations and mapping the one or more locations to the content receiver.

In various embodiments, a set of observation data corresponding to indications of detected receiver operations associated with the content receiver may be processed. Based at least in part on the set of observation data, the one or more content alternatives may be identified. In various embodiments, a set of observation data corresponding to indications of detected receiver operations associated with a plurality of content receivers may be processed. Based at least in part on the set of observation data, the one or more content alternatives may be identified. In various embodiments, the system may include the content receiver, and the content receiver may include the one or more processing devices. In various embodiments, the one or more processing devices may correspond to a server system that is separate and remote from the content receiver.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a content distribution system, in accordance with disclosed embodiments per the present disclosure.

FIG. 2 illustrates the content distribution system when adverse weather conditions cause a disruption in the reception of one or more satellite signals, in accordance with disclosed embodiments per the present disclosure.

FIG. 3 illustrates a content receiver that makes use of, interacts with, includes, and/or at least partially includes the content continuation subsystem, in accordance with disclosed embodiments per the present disclosure.

FIG. 4 illustrates a functional diagram of a system 400 that includes the content continuation subsystem, in accordance with disclosed embodiments per the present disclosure.

FIG. 5 illustrates an example method for facilitating continuation of content services in an event of signal loss, in accordance with disclosed embodiments per the present disclosure.

FIG. 6 illustrates a computer system, in accordance with disclosed embodiments according to the present disclosure.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

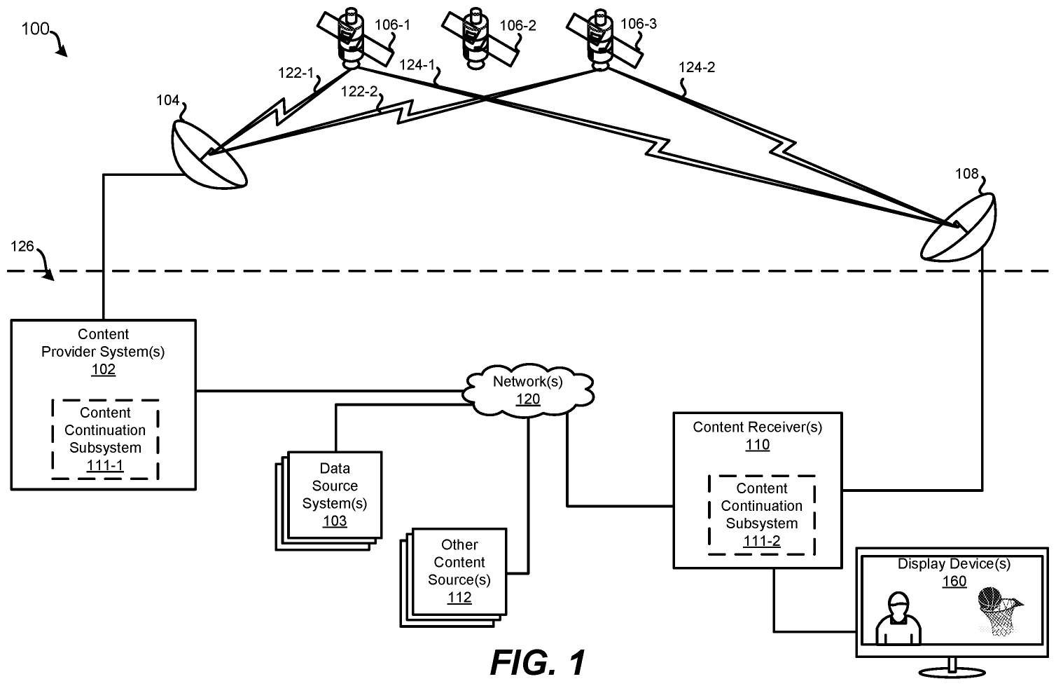

Various embodiments will now be discussed in greater detail with reference to the accompanying figures, beginning with FIG. 1.

FIG. 1 illustrates a content distribution system 100, in accordance with disclosed embodiments of the present disclosure. For brevity, system 100 is depicted in a simplified and conceptual form, and may generally include more or fewer systems, devices, networks, and/or other components as desired. Further, the number and types of features or elements incorporated within the system 100 may or may not be implementation-specific, and at least some of the aspects of the system 100 may be similar to a cable television distribution system, an IPTV (Internet Protocol Television) content distribution system, and/or another type of media or content distribution system.

The system 100 may include a content service provider system 102 (e.g., a television service provider system), a satellite uplink 104, a plurality of orbiting (e.g., geosynchronous) satellites 106, a satellite receiver 108, one or more content receivers 110, one or more content sources 112 (e.g., online content sources), and one or more data source systems 103. In some embodiments, each content receiver 110 may include a content continuation subsystem 111. Additionally or alternatively, the content provider system 102 may include a content continuation subsystem 111 in whole or in part. Additionally or alternatively, one or more data source systems 103 may include a content continuation subsystem 111 in whole or in part. Additionally or alternatively, one or more computing devices 116 may include a content continuation subsystem 111 in whole or in part.

The content continuation subsystem 111 may be configured to facilitate various content continuation features in accordance with various embodiments disclosed herein. The extent to which the receivers 110 may be configured to provide features of the subsystem 111 (e.g., by way of software updates and communications from the system 102) may depend on the processing power and storage capabilities of a given receiver 110. The system 102 may communicate with a given receiver 110 to pull specifications and current device capability information from the receiver 110. Based on such communications, the system 102 may the extent to which the receiver 110 can be configured to provide features of the subsystem 111 and may operate accordingly. For example, the system 102 may push one or more software packages to the receiver 110 to configure the receiver 110 to provide a set of one or more features of the subsystem 111. In instances where the receiver 110 lacks sufficient processing and/or storage capabilities, the subsystem 111 may operate on the system 102. Further, in some embodiments, additionally or alternatively, one or more data source systems 103 may include a content continuation subsystem 111 in whole or in part. The content continuation subsystem 111 may be configured to facilitate various content service continuation features in accordance with various embodiments disclosed herein.

In general, the system 100 may include a plurality of networks 120 that can be used for bi-directional communication paths for data transfer between components of system 100. Disclosed embodiments may transmit and receive data, including video content, via the networks 120 using any suitable protocol(s). The networks 120 may be or include one or more next-generation networks (e.g., 5G wireless networks and beyond). Further, the plurality of networks 120 may correspond to a hybrid network architecture with any number of terrestrial and/or non-terrestrial networks and/or network features, for example, cable, satellite, wireless/cellular, or Internet systems, or the like, utilizing various transport technologies and/or protocols, such as radio frequency (RF), optical, satellite, coaxial cable, Ethernet, cellular, twisted pair, other wired and wireless technologies, and the like. In various instances, the networks 120 may be implemented with, without limitation, satellite communication with a plurality of orbiting (e.g., geosynchronous) satellites, a variety of wireless network technologies such as 5G, 4G, LTE (Long-Term Evolution), 3G, GSM (Global System for Mobile Communications), another type of wireless network (e.g., a network operating under Bluetooth®, any of the Institute of Electrical and Electronics (IEEE) 802.11 suite of protocols, and/or any other wireless protocol), a wireless local area network (WLAN), a HAN (Home Area Network) network, another type of cellular network, the Internet, a wide area network (WAN), a local area network (LAN) such as one based on Ethernet, Token-Ring and/or the like, such as through etc., a gateway, and/or any other appropriate architecture or system that facilitates the wireless and/or hardwired packet-based communications of signals, data, and/or message in accordance with embodiments disclosed herein.

In various embodiments, the networks 120 and its various components may be implemented using hardware, software, and communications media such wires, optical fibers, microwaves, radio waves, and other electromagnetic and/or optical carriers; and/or any combination of the foregoing and/or the like. In some embodiments, the networks 120 may include a telephone network that may be circuit switched, package switched, or partially circuit switched and partially package switched. For example, the telephone network may partially use the Internet to carry phone calls (e.g., through VoIP). In various instances, the networks 120 may transmit data using any suitable communication protocol(s), such as TCP/IP (Transmission Control Protocol/Internet protocol), SNA (systems network architecture), IPX (Internet packet exchange), UDP, AppleTalk, and/or the like.

Many embodiments may include a large number of content provider systems 102, data source systems 103, and/or end-user equipment. The content provider systems 102 may distribute/broadcast video content to the receivers 110 via one or more networks of the networks 120. For example, a content provider system 102 may be configured to stream, via the networks 120, television channels, live sporting events and other competitions, on-demand programming, movies, other shows, television programs or portions of television programs following and/or during a live broadcast of the television programs, announcement content and commercials, programming information (e.g., table data, electronic programming guide (EPG) content, etc.), and/or other services to receivers 110 via satellite, 5G, 4G, and/or LTE wireless communication protocols and network components, in accordance with embodiments disclosed herein. The content provider system 102 may include one or more content server systems configured to stream television programming, including televised events such as sports events, to the receivers 110 via the network 120. When the streaming content servers stream content to the receivers 110, the stream content may be processed and displayed by the receivers 110 using one or more applications installed on the receivers 110. Some such streaming services may require a subscription and may require user authentication, e.g., with a username and/or password which may or may not be associated with an account map to the content receiver 110. Accordingly, the streaming services may make a television program available for streaming or download during the live broadcast of the television program.

The content provider system 102 and satellite transmitter equipment (which may include the satellite uplink 104) may be operated by a content provider. A content provider may distribute television channels, on-demand programming, programming information, and/or other services to users via satellite and one or more of the networks 120. The content provider system 102 may receive feeds of such content from various sources. The television channels may include multiple television channels that contain the same content (but may be in different formats, such as high-definition and standard-definition). To distribute such video content to endpoint devices 116, feeds of the video content may be relayed to endpoint equipment and the endpoint devices 116 via one or more satellites in the form of transponder streams. Satellite transmitter equipment may be used to transmit a feed of one or more television channels from the content provider system 102 to one or more satellites 106. While a single content provider system 102 and satellite uplink 104 are illustrated as part of the television distribution system 100, it should be understood that multiple instances of transmitter equipment may be used, possibly scattered geographically to communicate with satellites 106. Such multiple instances of satellite transmitting equipment may communicate with the same or with different satellites 106.

The data source systems 103 may correspond to any suitable sources of forecasted and current weather data such as one or more computer systems, databases, websites, portals, any repositories of data in any suitable form, server systems, other endpoint devices like endpoint devices 116 but functioning as data sources, and/or the like. In some instances, the data source systems 103 may include one or more of a database, a website, any repository of data in any suitable form, a third-party system, monitoring systems local to a site that detect data indicative of events (e.g., temperature, wind speed, and/or other sensor systems) and/or components thereof. By way of example, the one or more data sources may be sources of event data indicative of environmental events such as forecast, current, and/or real-time information for regions wherein receivers 110 are located including one or more sites relating to: weather conditions (e.g., rainstorm, snowstorm, typhoon, hurricane, overcast, etc.) from a weather service using real-time weather analytics and/or the like. Weather data gathered from a weather service (e.g., a system 103) may be determined by the content continuation subsystem 111 to correspond to certain types of weather events based at least in part on keyword recognition, alert recognition, and the like. In some embodiments, weather data gathered from a weather service may be determined by the content continuation subsystem 111 to correspond to certain types of weather events based at least in part on comparing the data to one or more thresholds.

In various embodiments, the data from one or more of the data source systems 103 may be retrieved and/or received by the content continuation subsystem 111 via one or more data acquisition interfaces through network(s) 120 and/or through any other suitable means of transferring data. In various embodiments, the content continuation subsystem 111 and the data source systems 103 could use any suitable means for direct communication. In various embodiments, the content continuation subsystem 111 may actively gather and/or pull from one or more of the data source systems 103. Additionally or alternatively, the content continuation subsystem 111 may wait for updates from one or more of the data source systems 103. The data collected (e.g., weather data indicating weather for particular locations) may be curated so that only the data necessary for the transaction is collected. The one or more data acquisition interfaces may include one or more application programming interfaces (APIs) that define protocols and routines for interfacing with the data source systems 103. The APIs may specify application programming interface (API) calls to/from data source systems 103. In some embodiments, the APIs may include a plug-in to integrate with an application of a data source systems 103. The data acquisition interfaces, in some embodiments, could use a number of API translation profiles configured to allow interface with the one or more additional applications of the data sources to access data (e.g., a database or other data store) of the data source systems 103. The API translation profiles may translate the protocols and routines of the data source systems 103 to integrate at least temporarily with the system and allow communication with the system by way of API calls.

The content receivers 110, as described throughout, may generally be any type of content receiver (such as an STB (set-top box), for example) configured to decode signals received for output and presentation via a display device 160 and may also be referenced herein as television receivers 110. In another example, content receiver 110 (which may include another remote content receiver 110) may be integrated as part of or into a television, a DVR, a computing device, such as a tablet computing device, or any other computing system or device, as well as variations thereof. In some embodiments, a content receiver 110 may be a component that is added into the display device 160, such as in the form of an expansion card. A content receiver 110 and network 120 together with content receivers 110 and/or one or more computing devices 116, may form at least a portion of a particular home computing network, and may each be respectively configured such as to enable communications in accordance with any particular communication protocol(s) and/or standard(s) including, for example, TCP/IP (Transmission Control Protocol/Internet Protocol), DLNA/DTCP-IP (Digital Living Network Alliance/Digital Transmission Copy Protection over Internet Protocol), HDMI/HDCP (High-Definition Multimedia Interface/High-Bandwidth Digital Content Protection), etc. While only one content receiver 110, display device 160, etc. are illustrated in FIG. 1, it should be understood that multiple (e.g., tens, thousands, millions) instances of such equipment, corresponding to various users in various geolocations, may be included the system 100.

In some embodiments, broadcast televised events may be delivered to content receivers, including a content receiver 110, via satellite according to a schedule. On-demand content may also be delivered to a content receiver 110 via satellite or via the network 120. Satellites 106 may be configured to receive uplink signals 122 from satellite uplink 104. In this example, uplink signals 122 may contain one or more transponder streams of particular data or content, such as particular television channels, each of which may be supplied by content provider system 102. For example, each of uplink signals 122 may contain various media content such as HD (High Definition) television channels, SD (Standard Definition) television channels, on-demand programming, programming information (e.g., table data), and/or any other content in the form of at least one transponder stream, and in accordance with an allotted carrier frequency and bandwidth. In this example, different media content may be carried using different satellites of satellites 106. Further, different media content may be carried using different transponders of a particular satellite (e.g., satellite 106-1); thus, such media content may be transmitted at different frequencies and/or different frequency ranges. For example, a first television channel and a second television channel may be carried on a first carrier frequency over a first transponder (as part of a single transponder stream) of satellite 106-1, and a third, fourth, and fifth television channel may be carried on a second carrier frequency (as part of another transponder stream) over a transponder of satellite 106-3, or, the third, fourth, and fifth television channel may be carried on a second carrier frequency over a second transponder of satellite 106-1, etc.

The satellites 106 may be further configured to relay uplink signals 122 to the satellite receiver 108 as downlink signals 124. Similar to the uplink signals 122, each of the downlink signals 124 may contain one or more transponder streams of particular data or content, such as various encoded and/or at least partially scrambled television channels, on-demand programming, etc., in accordance with an allotted carrier frequency and bandwidth. The satellite receiver 108, which may include a satellite dish, a low noise block (LNB), and/or other components, may be provided for use to receive television channels, such as on a subscription basis, distributed by the content provider system 102 via the satellites 106. For example, the satellite receiver 108 may be configured to receive particular transponder streams as downlink signals 124, from one or more of the satellites 106. Based at least in part on the characteristics of a given content receiver 110 and/or satellite receiver 108, it may only be possible to capture transponder streams from a limited number of transponders of the satellites 106 concurrently. For example, a tuner of the content receiver 110 may only be able to tune to a single transponder stream from a transponder of a single satellite, such as the satellite 106-1, at a time.

The content receiver 110, which may be communicatively coupled to the satellite receiver 108, may subsequently select, via a tuner, decode, and relay television programming to a television for display thereon. Broadcast television programming or content may be presented “live,” or from a recording as previously stored on, by, or at the content receiver 110. For example, an HD channel may be output to a television by the content receiver 110 in accordance with the HDMI/HDCP content protection technologies. Other embodiments are possible. For example, in some embodiments, an HD channel may be output to a television in accordance with the MoCA® (Multimedia over Coax Alliance) home entertainment networking standard. Other embodiments are possible.

The content receiver 110 may select via tuner, decode, and relay particular transponder streams to one or more of content receivers 110, which may in turn relay particular transponder streams to one or more display devices 160. For example, the satellite receiver 108 and the content receiver 110 may, respectively, be configured to receive, decode, and relay at least one television channel to a television by way of a content receiver 110. Similar to the above example, a television channel may generally be presented “live” or from a recording as previously stored by the content receiver 110 and may be output to the display device 160 by way of the content receiver 110 in accordance with a particular content protection technology and/or networking standard. Other embodiments are possible.

In various embodiments, the content resources 126 may be used to provide the content receiver 110 with content (e.g., televised and streamed events). The content resources 126 may be used to retrieve televised and/or otherwise streamed events or portions of thereof following and/or during a live broadcast of the televised and/or otherwise streamed events. The content resources 126 may include the content provider system 102, the service provider systems 103, the online content sources 112, one or more other content receivers 110, and/or the like.

The content provider system 102, which may distribute broadcast televised and/or otherwise streamed events to the content receivers 110 via a satellite-based television programming distribution arrangement (or some other form of television programming distribution arrangement, such as a cable-based network, fiber-based network, or IP-based network, may use an alternate communication path, such as via one or more of the networks 120, to provide televised and/or otherwise streamed events to the content receivers 110. The content receivers 110 may be permitted to request various television programs or portions of televised and/or otherwise streamed events from the content provider system 102 via the network 120. For instance, the content provider system 102 may be permitted to transmit a portion of a television program or an entire television program during and/or after a time at which the television program was broadcast live by the content provider via a satellite-based television programming distribution arrangement.

In some embodiments, the content provider system 102 may provide a televised and/or otherwise streamed event via on-demand content. Such on-demand content may be provided via the satellite-based distribution arrangement and/or via the network 120. On-demand content provided via the satellite-based distribution arrangement may be stored locally by the content receiver 110 to allow on-demand access. On-demand content may also be retrieved via the network 120 from the content provider system 102.

In some embodiments, the other content sources 112 may represent content resources through which televised and/or otherwise streamed events may be retrieved by the content receiver 110 via the network 120. Each of the content sources 112 may represent different websites available via the Internet. Periodically, the content receiver 110 may poll content sources 112 to determine which televised and/or otherwise streamed events are available and/or which television programs are scheduled to be available in the future. In some embodiments, the content receiver 110 may poll online content sources 112 regarding the availability of at least a portion of a specific televised and/or otherwise streamed event.

In various embodiments, the data from the one or more data source systems 103 and/or one or more data sources 112 may be retrieved and/or received by the content provider system 102 and/or the subsystem(s) 111 via one or more data acquisition interfaces through network(s) 120 and/or through any other suitable means of transferring data. Data, as referenced herein, may correspond to any one or combination of raw data, unstructured data, structured data, information, and/or content which may include media content, text, documents, files, instructions, code, executable files, images, video, audio, and/or any other suitable content suitable for embodiments of the present disclosure. In various embodiments, the content provider system 102 and/or the subsystem(s) 111 and the data source systems 103 and/or the data sources 112 could use any suitable means for direct communication.

Teachings of the present disclosure may be implemented in a variety of configurations that may correspond to the configurations disclosed herein. As such, certain aspects of the methods disclosed herein may be omitted, and the order of the steps may be shuffled in any suitable manner and may depend on the implementation chosen. Moreover, while the aspects of the methods disclosed herein, may be separated for the sake of description, it should be understood that certain steps may be performed simultaneously or substantially simultaneously.

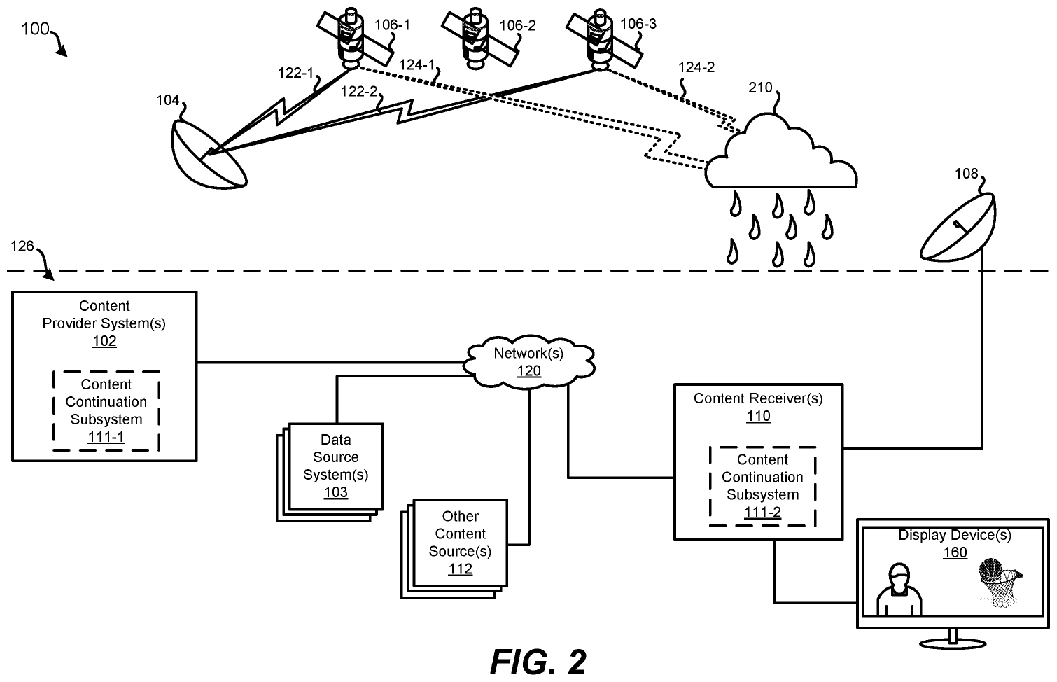

FIG. 2 illustrates the content distribution system 100 when adverse weather conditions cause a disruption in the reception of one or more satellite signals. Various weather conditions may interfere with reception of one or more satellite signals. For illustration, a rainstorm 210 is depicted which may obstruct the satellite receiver 108 (e.g., a satellite dish) from adequately receiving downlink signals 124. In FIG. 2, a rainstorm is used as an example of one type of occurrence that may prevent one or more television channels, for example, from being received successfully by user equipment (e.g., satellite receiver 108, content receiver 110, display 160). Other occurrences that may prevent one or more television channels from being successfully received by user equipment may include: a satellite outage, an outage of one or more particular transponders of a satellite 106, an outage at the satellite uplink 104, disruption of uplink signals 122, an uplink signal not being received by the proper satellite 106, the television channel not being initially received by the satellite uplink 104, and/or a planned maintenance outage. However, the content continuation subsystem 111 may provide for continuation of content services despite the disruption in the signals in the event of any such occurrences.

The content continuation subsystem 111 may be configured to perform one or more methods for facilitating continuation of content services in an event of signal loss, as disclosed herein. In various embodiments, the content receiver 110 and/or the system 102 may perform all or part of the methods, with a single media device or multiple media devices performing the methods. In various embodiments, part or all of the methods may be performed while a content receiver 110 is supposed to be receiving televised, streamed and/or otherwise digitally distributed content and/or is supposed to be outputting the content for display but actually is experiencing a signal loss that prevents such reception and output. In various embodiments, at least part of the methods may be performed in advance of the televised, streamed and/or otherwise digitally distributed content and, thus, may be performed while the content is scheduled but before the content is to be transmitted to endpoint media devices and/or before the content is to be output by an endpoint media device for display.

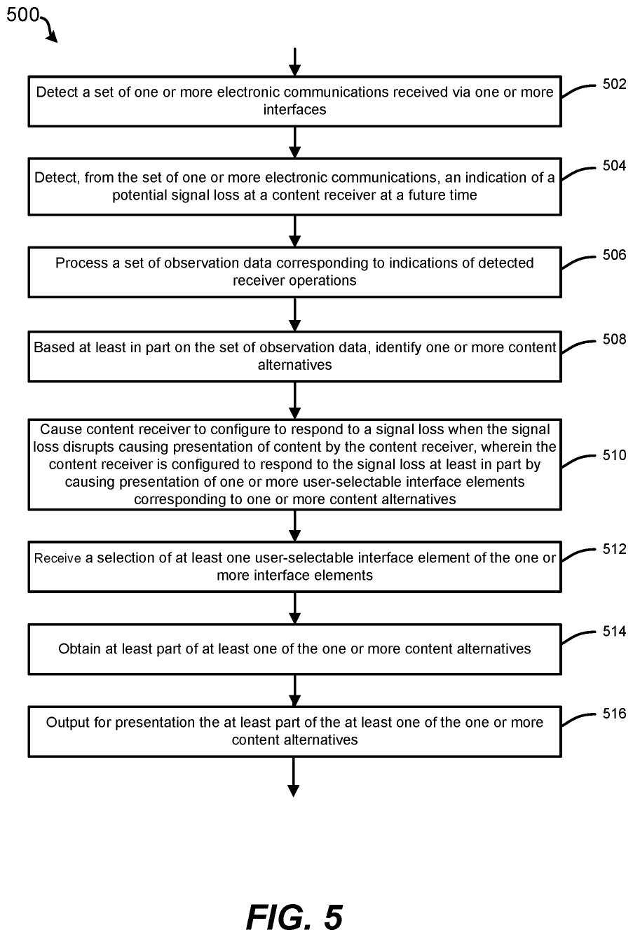

FIG. 5 illustrates an example method 500 for facilitating continuation of content services in an event of signal loss, in accordance with embodiments of the present disclosure. One or a combination of the aspects of the method 500 may be performed in conjunction with one or more other aspects disclosed herein, and the method 500 is to be interpreted in view of other features disclosed herein and may be combined with one or more of such features in various embodiments.

As indicated by block 502, one or more sets of one or more electronic communications may be received via one or more interfaces and detected. As indicated by block 504, an indication of a potential signal loss at a content receiver at a future time may be detected from the set of one or more electronic communications. The detection of the indication of the potential signal loss may be based at least in part on forecasted weather conditions for a location corresponding to the content receiver 110. Weather data from the set of one or more electronic communications may be obtained, and the potential signal loss may be determined based at least in part on analyzing the weather data for one or more one or more locations and mapping the one or more locations to the content receiver 110.

Additionally or alternatively, the detection of the indication of the potential signal loss may be based at least in part on outage conditions for other content receivers 110 in or near a location corresponding to the content receiver 110. Outage data for a plurality of content receivers may be obtained from the set of one or more electronic communications. The potential signal loss may be determined based at least in part on analyzing the outage data for one or more one or more locations and mapping the one or more locations to the content receiver 110. This may include detecting signal loss indicators by geolocation of other content receivers 110 in an area around the content receiver 110 and determining the potential signal loss based at least in part on the detected signal loss indicators.

As indicated by block 506, a set of observation data corresponding to indications of detected receiver operations associated with the content receiver 110 and/or a plurality of other content receivers 110 may be processed. As indicated by block 508, based at least in part on the set of observation data, one or more content alternatives may be identified. As indicated by block 510, consequent to the detecting the indication of the potential signal loss, the content receiver 110 may be caused to configure to respond to a signal loss when the signal loss disrupts causing presentation of content by the content receiver. The content receiver 110 may be configured to respond to the signal loss at least in part by causing presentation of one or more user-selectable interface elements corresponding to the one or more content alternatives.

As indicated by block 512, the content receiver 110 may receive a selection of at least one user-selectable interface element of the one or more interface elements. As indicated by block 514, the content receiver 110 may obtain at least part of at least one of the one or more content alternatives. As indicated by block 516, the content receiver 110 may output for presentation the at least part of the at least one of the one or more content alternatives. Aspects of the method 500 are further disclosed below in relation to other figures.

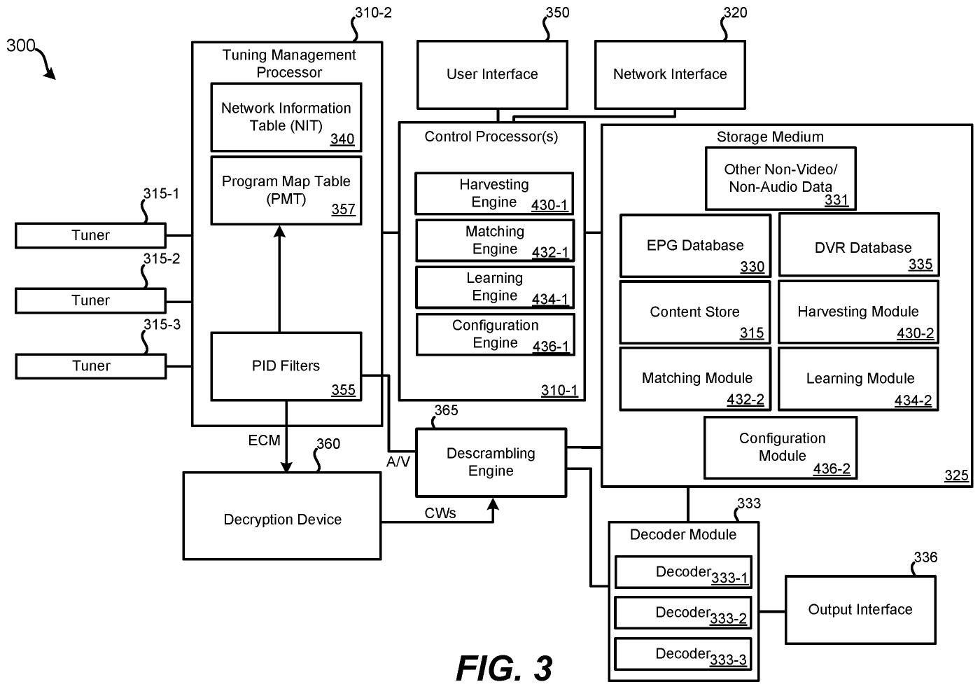

FIG. 3 illustrates a content receiver 300 that makes use of, interacts with, includes, and/or at least partially includes the content continuation subsystem 111, in accordance with certain embodiments according to the present disclosure. Certain embodiments of the receiver 300 may include set top boxes (STBs), over-the-top receivers, and/or other content receivers. In some embodiments, the receiver 300 may correspond to the content receiver 110. In various embodiments, in addition to being in the form of a STB, a receiver may be incorporated as part of another device, such as a television or other form of display device, such as a computer, smartphone, tablet, or other handheld portable electronic device. For example, a television may have an integrated receiver (which does not involve an external STB being coupled with the television). One or a combination of the content harvesting engine 430-1, matching engine 432-1, learning engine 434-1, and/or configuration engine 436-12 may be provided in conjunction with content harvesting module 430-2, matching module 432-2, learning module 434-2, and/or configuration module 436-2 to implement various functionalities of the content continuation subsystem 111 into the receiver 300.

The receiver 300 may represent receiver 110 of FIG. 1 and may be in the form of a STB that communicates with a display device such as a television. The receiver 300 may be incorporated as part of a television, such as the display device 160 of FIG. 1. The receiver 300 may include: processors 310 (which may include control processor 310-1, tuning management processor 310-2, and possibly additional processors), tuners 315 (e.g., tuners 315-1, 315-2, 315-3), network interface 320, non-transitory computer-readable storage medium 325, electronic programming guide (EPG) database 330, networking information table (NIT) 340, digital video recorder (DVR) database 345, content store 315, user interface 350, decryption device 360, decoder module 333, interface 336, and/or descrambling engine 365. In other embodiments of receiver 300, fewer or greater numbers of components may be present. It should be understood that the various components of receiver 300 may be implemented using hardware, firmware, software, and/or some combination thereof. Functionality of components may be combined; for example, functions of descrambling engine 365 may be performed by tuning management processor 310-2. Further, functionality of components may be spread among additional components; for example, PID filters 355 may be handled by separate hardware from program map table 357. The receiver 300 may be in data communication with service provider systems 102 and/or other content sources 112, such as by way of network interface 320.

The network interface 320 may be used to communicate via an alternate communication channel with a content provider system 102, if such communication channel is available. The primary communication channel may be via satellite (which may be unidirectional to the receiver 300) and the alternate communication channel (which may be bidirectional) may be via a network, such as the Internet. Referring back to FIG. 1, receiver 110 may be able to communicate with content provider system 102 via a network 120, such as the Internet. This communication may be bidirectional: data may be transmitted from the receiver 110 to the content provider system 102 and from the content provider system 102 to the receiver 110. Referring back to FIG. 3, the network interface 320 may be configured to communicate via one or more networks, such as the Internet, to communicate with the content provider system 102, data source systems 103, and other content sources 112 of FIG. 1.

The storage medium 325 may represent one or more non-transitory computer-readable storage media. The storage medium 325 may include memory and/or a hard drive. The storage medium 325 may store information related to the EPG database 330, other non-video/non-audio data 331, DVR database 345, harvesting engine 430-2, matching engine 432-2, learning engine 434-2, configuration engine 436-2, the other modules, and/or the like. Recorded television programs and other content may be stored using the storage medium 325 as part of the DVR database 345.

The EPG database 330 may store information related to television channels and the timing of programs appearing on such television channels. The EPG database 330 may be stored using the storage medium 325. Information from the EPG database 330 may be used to inform users of what television channels or programs are popular and/or provide recommendations to the user. Information from the EPG database 330 may be provided to the user with a visual interface displayed by a television that allows a user to browse and select television channels and/or television programs for viewing and/or recording. Information used to populate the EPG database 330 may be received via the network interface 320 and/or via satellites, such as the satellites 106 of FIG. 1 via the tuners 315. For instance, updates to the EPG database 330 may be received periodically via satellite. The EPG database 330 may serve as an interface for a user to control DVR functions of the receiver 300, and/or to enable viewing and/or recording of multiple television channels simultaneously. Information from EPG database 330 may be output as a video stream to a display device. A particular user may issue commands indicating that an EPG interface be presented. A user issuing a command that an EPG be displayed may constitute a change command.

The output interface 336 may serve to output a signal to a television (or another form of display device) in a proper format for display of video and playback of audio. As such, the television interface 336 may output one or more television channels, stored television programming from the storage medium 325 (e.g., television programs from the DVR database 345, information from the EPG database 330, etc.), and/or the like to a television for presentation.

User profiles may also be stored in the storage medium 345 and may include stored user preferences that may be inferred by the content receiver 300 based at least in part on viewing history. The content receiver 300 may communicate user profile information to the service system(s) 102, 103 to request content items tailored to the inferred user preferences to provision content alternatives 452 in accordance with certain embodiments disclosed herein. The user profiles may include profiles for multiple users or may include a single profile for the content receiver in general. The user profiles may observation data and personalized pattern data disclosed further herein.

The user interface 350 may include a remote control (physically separate from the receiver 300) and/or one or more buttons on the receiver 300 that allow a user to interact with the receiver 300. The user interface 350 may be used to select a television channel for viewing, view information from the EPG database 330, and/or program a timer stored to DVR database 345, wherein the timer is used to control the DVR functionality of the control processor 310-1. The user interface 350 may also be used to transmit commands to the receiver 300 and make user selections to customize user preferences.

For simplicity, the receiver 300 of FIG. 3 has been reduced to a block diagram; commonly known parts, such as a power supply, have been omitted. Further, some routing between the various modules of the receiver 300 has been illustrated. Such illustrations are for exemplary purposes only. The state of two modules not being directly or indirectly connected does not indicate the modules cannot communicate. Rather, connections between modules of the receiver 300 are intended only to indicate possible common data routing. It should be understood that the modules of the receiver 300 may be combined into a fewer number of modules or divided into a greater number of modules.

Further, the components of the content receiver 300 may be part of another device, such as built into a television. The content receiver 300 may include one or more instances of various computerized components, such as disclosed in relation to computer systems disclosed further herein. While the content receiver 300 has been illustrated as a satellite receiver, it is to be appreciated that techniques below may be implemented in other types of television receiving devices, such as cable receivers, terrestrial receivers, IPTV receivers or the like. In some embodiments, the content receiver 300 may be configured as a hybrid receiving device, capable of receiving content from disparate communication networks, such as satellite and terrestrial television broadcasts. In some embodiments, the tuners may be in the form of network interfaces capable of receiving content from designated network locations.

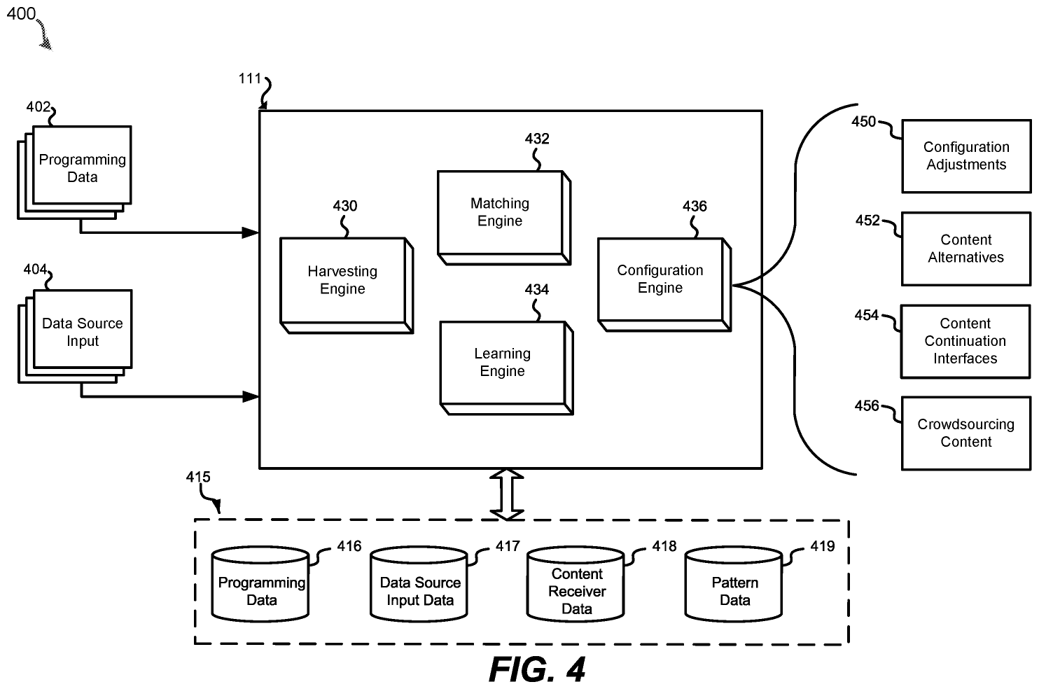

FIG. 4 illustrates a functional diagram of a system 400 that includes the content continuation subsystem 111, in accordance with disclosed embodiments of the present disclosure. In various embodiments, the system 400 may be included in whole or in part in the content provider system 102 and/or a content receiver 110. In some embodiments, the system 400 may be separate from the content provider system 102. In some embodiments, the system 400 may be included in the end-user system and may be included in the content receiver 110 and/or one or more computing devices. In some embodiments, various features of the system 400 may be distributed between the content receiver 110 and upstream of the content receiver 110. While not all components of the system 400 are shown, the system 400 may include one or a combination of such components.

As depicted, the system 400 includes the content continuation subsystem 111. The content continuation subsystem 111 may include or otherwise correspond to an audiovisual control engine that, as with disclosed embodiments of the other engines, may include instructions retained in processor-readable media and to be executed by one or more processors. The content continuation subsystem 111 may be communicatively coupled with interface components and communication channels (e.g., of the content receiver 110, which may take various forms in various embodiments as disclosed herein) configured to receive programming data 402, which may correspond to data regarding televised programming, television shows, movies, televised events, and/or the like that may be available currently and/or at a future time. In various embodiments, the programming data 402 may include data regarding audiovisual content broadcast and/or otherwise transmitted by the content provider 102 and/or one or more other service providers 103 by way of one or a combination of streaming over IP, live streaming over IP, video-on-demand delivered over IP, other online delivery, over the air delivery, cable-television distribution, satellite television distribution, and/or the like. In some embodiments, the programming data 402 may include various components, including without limitation, one or more video tracks, audio tracks, audio video tracks, metadata tracks, close captioning information, and/or the like. In some embodiments, the system 400 may retain received programming data 402 in programming data storage 416 in content storage 415. The content storage 415 may include any suitable form of storage media, such as any suitable form disclosed herein.

The content continuation subsystem 111 may be further configured to receive data source input 404. The data source input 404 may include the data from the one or more data source systems 103 disclosed above. As an example, data source input 404 may include, but is not limited to, updates (real-time and/or otherwise) and/or continuous data streams received from one or more data source systems 103, which, as disclosed above, may include forecasted, current, and/or real-time weather data for regions wherein receivers 110 are located. In embodiments where the subsystem 111 is included in the content receiver 110, the weather data and, hence, the data source input 404 may be for the location in which the receiver 110 is currently located. The data source input 404 may be received by the content receiver 110 from a data source system 103 and/or from the content provider system 102. In embodiments where the subsystem 111 is included in the content provider system 102, the weather data and data source input 404 may be for one or more locations in which one or more content receivers 110 are located. The data source input 404 may be received by the content provider system 102 from a data source system 103.

The content continuation subsystem 111 may include a harvesting engine 430 configured to aggregate programming data 402 and data source input 404 in order to facilitate content service continuation features disclosed herein. The content continuation subsystem 111 may include a matching engine 432, which, in various embodiments, may be configured to analyze, match, classify, categorize, characterize, tag, and/or annotate programming data 402, data source input 404, and content receiver data 418.

From the data source input 404, the content continuation subsystem 111 may determine forecasted weather conditions for particular areas that may disrupt signals to the content receiver 110. The data source input 404 may include weather data gathered from a weather service. The weather data may be collected and analyzed at any suitable time in advance of an upcoming weather event (e.g., corresponding to weather forecasts weeks, days, hours, minutes, etc. in advance). In some embodiments, the content continuation subsystem 111 may utilize outage information for a plurality of receivers instead of, or in addition to, weather conditions. The service provider system 102 may receive indications of outages for the plurality of receivers 110, which indications may be pushed by the content receivers 110 or may be pulled from the content receivers 110 on a periodic or other basis.

The content continuation subsystem 111 may analyze (e.g., with the matching engine 432) the weather data to match, classify, categorize, characterize, tag, and/or annotate the weather data as relevant to one or more locations in which one or more content receivers 110 are located. In embodiments where the content continuation subsystem 111 is included in the content receiver 110, the content continuation subsystem 111 may determine which weather data is mapped to the single location of the content receiver 110. The location data corresponding to the location of the content receiver 110 may be stored by the content receiver 110 in the content receiver data storage 418. Similarly, in some embodiments, the service provider system 102 may analyze outage data to determine areas affected by the outages and may map those areas to other content receivers 110 that may potentially be affected by an outage as well.

In embodiments where the content continuation subsystem 111 is included in the content provider system 102, the content continuation subsystem 111 may determine which weather data is mapped to which content receivers 110 in a plurality of locations. Thus, the content continuation subsystem 111 may map weather data to content receivers 110 on a large scale, with the content receivers 110 being in a variety of locations over a large area (e.g., state, country, etc.), which location data may be stored by the content provider system 102 in the content receiver data storage 418. To facilitate geo-discrimination to differentiate which sets of whether data apply to which content receivers 110, disclosed embodiments may provide for capturing and analyzing location data for the content receivers 110 to determine current locations of the content receivers 110 and which weather data applies as a function of the current device locations, disclosed embodiments may provide for capturing and analyzing location data for the content receivers 110. In various embodiments, the matching engine 432 may include a location correlation engine that may correlate location data corresponding to the weather data to a set of one or more zip codes (or other types of geographical codes) corresponding to a set of one or more content receivers 110 mapped to the set of one or more zip codes (or other geographical codes) via identifiers keyed with one or more tables and/or indexes. Similarly, in some embodiments, the service provider system 102 may perform such operations and make corresponding determinations using outage data instead of, or in addition to, weather data.

The content continuation subsystem 111 may analyze the weather data and determine that the weather data indicates certain types of weather events that have a low probability of causing signal loss, have a medium probability of causing signal loss, or have a high probability of causing signal loss. In so doing, the content continuation subsystem 111 may use correlation rules to compare the weather data to one or more thresholds, specifications of weather-specific conditions, specifications of weather-specific criteria, and/or the like. By way of example, the correlation rules may include correlation criteria that could include respective weightings assigned to the particular criteria. Hence, each type of the above criteria could be assigned a weight according to its significance. Specifications of the criteria and weightings could be implemented in any suitable manner, including lists, tables, matrices, and/or the like, and could be organized in a rank order and/or any hierarchical structure according to weight. Some embodiments may have specifications of the criteria and weightings organized according to decision tree, with contingencies so that only certain combinations of criteria may be considered. In some embodiments, the service provider system 102 may perform such operations and make corresponding determinations using outage data instead of, or in addition to, weather data.

Consequent to the content continuation subsystem 111 determining that the weather data and/or the outage data indicates an upcoming weather and/or outage event that has a high probability of causing signal loss (and, in some embodiments, even if it has a medium probability of causing signal loss), the content continuation subsystem 111 may cause a set of one or more content receivers 110 in the affected area to be configured to respond to any upcoming signal loss with continuation of content services features disclosed further herein. The content continuation subsystem 111 may include a configuration engine 436 configured to cause the content receiver 110 to make one or more configuration adjustments 450 to provision one or more continuation services features. In some embodiments, the configuration engine 436 may analyze input monitored by the harvesting engine 430, determinations of the matching engine 432, and/or information stored in one or more storage repositories 415 to make configuration adjustment 450 determinations. Based at least in part on one or more configuration adjustment 450 determinations, the configuration engine 436 may cause activation of one or more configuration adjustment 450 actions, which may include causing the content receiver 110 to perform one or more operations. The causing may include one or a combination of communicating instructions, specifications, parameters, graphics, video, audio, one or more links, other data, and/or the like to the content receiver 110 in order to cause the content receiver 110 to be configured to respond to an upcoming signal loss.

For example, with one or more configuration adjustments 450, the content continuation subsystem 111 may cause the content receiver 110 to be configured to output one or more interface elements corresponding to recommended content alternatives 452 disclosed herein. The content continuation subsystem 111 may cause the content receiver 110 to be configured to output one or more content continuation interfaces 454 that present content alternatives 452 452 that allow for user selection of the content alternatives 452, which, when a corresponding interface element is selected, may instantiate a process or algorithm whereby a viewer may access the selected content alternative. The one or more interfaces may include text, one or more images, graphics, video, audio, one or more menus, one or more links, one or more URLs, buttons, other user interface elements, one or more screens, one or more windows, one or more overlays, and/or the like to present one or more content alternatives 452 and allow user selection to view one or more of them. In some embodiments, the one or more interfaces may be similar to an EPG interface, with similar descriptive content and selectable options. The one or more interfaces may present various information relating to content alternatives 452 which a user may select for immediate viewing.

The recommended content alternatives 452 may be based at least in part on observation data regarding what the user has watched, recorded, and/or otherwise shown interest in. The content continuation subsystem 111 may be configured to gather observation data, which may be specific to one or more particular identified users and/or may be generally related to one or more particular content receivers 110. The observation data may be stored in the content receiver data storage 418 and/or pattern data storage 419. The observation data may be gathered from one or more content receivers 110, and aggregated, consolidated, and transformed into viewer pattern profiles that include personalized pattern data 419.

In some embodiments, the content continuation subsystem 111 may anticipate time periods and corresponding matching content items based at least in part on the personalized pattern data 419. For example, the content continuation subsystem 111 may utilize patterns of viewing of certain types of content at certain times to anticipate likely future viewing times by specifying matching content items for presentation as alternatives for viewing if a signal loss occurs at those likely future viewing times. The content continuation subsystem 111 may create a schedule of various likely future viewing times and corresponding matching content items for presentation as alternatives for viewing if a signal loss occurs at those future times. The content receiver 110 may be instructed to utilize the schedule to effect the presentation of temporally matched content items should a signal loss occur at any of various times specified by the schedule.

In some embodiments where the content continuation subsystem 111 is at least partially included in the service provider system 102, the service provider system 102 may cause the content receiver 110 to make configuration adjustments 450 to configure for response to a signal loss with content alternatives 452. In some embodiments, the service provider system 102 may push content composites that include the instructions, specifications, parameters, graphics, video, audio, one or more links, other data, and/or the like to the content receiver 110 in order to cause the content receiver 110 to be configured to respond to an upcoming signal loss. In some embodiments, the service provider system may initially send a trigger (e.g., a weather alert trigger) to the content receiver 110 that would cause the content receiver 110 to be configured to respond to an upcoming signal loss. In various embodiments, the trigger may be sent to the content receiver 110 via closed captioning, via one or more vertical blanking intervals of a satellite signal, and/or via the network 120. The content receiver 110 may process and detect the trigger by way of text recognition, code recognition, instruction parsing, and in any other suitable manner.

In response to the trigger, the content receiver 110 may configure itself. This may include, in various embodiments, at least part of the content continuation subsystem 111 on the content receiver 110 performing any data collection, searching operations, obtaining content alternative 452 recommendations, formatting preparation of the content continuation interfaces 454, and the like disclosed herein to facilitate the content continuation features. In some embodiments, the content receiver 110 may retrieve at least part of the content composites from the service provider system 102 and/or the other content sources 112 in response to the trigger in order to provide the content alternatives 452 in response to a signal loss.

The content continuation subsystem 111 may include a learning engine 434 that may be an analysis engine. The learning engine 434 may employ machine learning. The learning engine 434 may further employ deep learning. Accordingly, the learning engine 434 may facilitate machine learning or, more specifically, deep learning, to facilitate creation, development, and/or use of viewer pattern data 419. As disclosed herein, the subsystem 111 may determine content that the viewer actually is viewing, is about to view (e.g., the televised event is scheduled to play on the channel that the viewer is currently viewing) or is likely to view as determined with the learning engine 434. In embodiments where the learning engine 434 is included in the content receiver 110, the content receiver 110 may be a self-observer that may gather observation data. In various embodiments, the data from the one or more content receivers 110 may be retrieved and/or received by the content continuation subsystem 111 via one or more data acquisition interfaces, which may include interfaces of the content continuation subsystem 111, the one or more content receivers 110, and/or the like-through network(s) 120 in various embodiments, through any suitable means for direct communication, and/or through any other suitable means of transferring data. According to various embodiments where the subsystem 111 is included in a service provider system 102, observation data may be actively gathered and/or pulled from the one or more content receivers 110.

To identify content alternatives 452, the content continuation subsystem 111 (e.g., using the matching engine 432 and/or the learning engine 434) may use the personalized pattern data 419 to identify matching programming content items. In some embodiments, the content continuation subsystem 111 may perform a search of various repositories for content items that have metadata matching the personalized pattern data 419, with the highest preference given to the content item that has metadata most closely matching the personalized pattern data 419. The content continuation subsystem 111 may search for suitable options to watch content via an IP connection or from local DVR storage 335 (i.e., without need for a satellite signal), such as DVR recordings, video on demand (VOD), other non-linear content, over-the air broadcast programming, live linear IP streaming, and/or the like. For example, the content continuation subsystem 111 may query one or more databases, such as the DVR database 335 of FIG. 3 and/or a server system of the content provider system 102 and/or a server system of the other content source systems 112 of FIG. 1, to identify any programming that may be matched to the programs identified by the viewer pattern data 419.

The searching may include querying, which may include actively gathering and/or pulling from one or more data sources, for example, by accessing a repository and/or by “crawling” the various repositories) for identical matches to the show the viewer is currently watching prior to a signal loss or one or more shows that the viewer is anticipated to watch based on the pattern data 419. For example, the same show may be available from a different, non-satellite source, such as the content provider system 102 or other content source systems 112 and may be available as video-on-demand or streaming over IP. The searching may further include querying for close matches, such as different episodes, sequels, prequels, etc. in the same series as the show the viewer is currently watching or is anticipated to watch, with preference being given to the shows that the viewer has not yet watched based on the observation data for the content receiver 110. The searching may further include querying for otherwise correlated matches, such as shows of the same category of action, drama, etc.; shows with the same actor; and/or shows sharing any suitable characteristics.

In some embodiments, the content continuation subsystem 111 may identify matching content in programming that is scheduled for a future time. The subsystem 111 may cause the content receiver 110 to automatically record the upcoming matching content so that the content may be available as an alternative should disruption of the satellite signal occur. For example, the content receiver 110 may be instructed to automatically record identical matches, close matches, and/or otherwise correlated matches. Then, after the recording of the content, the subsystem 111 may include the record content as a content alternative 452 to be presented to the viewer.

Having identified one or more closely matching content items, the content continuation subsystem 111 may specify one or more content receiver operations with configuration adjustments 450 to present content alternatives 452 corresponding to the content items. The content items may be ranked according to closest of matching and one or more of the content items may be presented in the content continuation interface 454 in order according to the ranking, from closest match to least close match. In some embodiments, the configuration adjustments 450 may cause the most closely matching content item to be played immediately upon detection of a signal loss. In such embodiments, one or more other content alternatives 452 may also be presented with the playing content item, for example, within overlay, pop-up, window, etc. with one or more interface options for selection by the user to view instead of the automatically played content item. In some embodiments, if the user does not select any option presented as a content alternative 452 after the one or more content alternatives 452 have been displayed for a predetermined time after a signal loss has been experienced, the content continuation subsystem 111 may cause the content receiver 110 to reboot for content receiver health maintenance, thereby advantageously utilizing the signal loss experience to improve the health of the content receiver 110.

The content continuation interface 454 may identify the source of each content item that is listed. In response to a user selection of the content item, the subsystem 111 may verify or confirm that an account associated with the viewer indicates the content is authorized is accessible (e.g., that a corresponding subscription exists). In some embodiments, the subsystem 111 may cause one or more other interfaces to be presented that allow for authorization if a subscription does not exist for a selected content item to allow for user agreement to terms and conditions to access the content item. In some embodiments, the subsystem 111 may coordinate with the service provider system 102 in order to gain access for the temporary time period of the signal loss, whereby the service provider system 102 may coordinate coverage of costs associated with the access. Of course, in response to a user selection of the content item that is already stored in the DVR database 335, the subsystem 111 need not verify rights of access.

Additionally or alternatively, in some embodiments, crowdsourcing content features 456 may be provided, and the searching for content alternatives 452 may include searching data sources corresponding to crowdsources. The service provider system 102 may collect data on content that is available from one or more of a plurality of content receivers 110 that are associated with the service provider system 102. Such content receivers 110 may be located in various geographical locations. The content available from various content receivers 110 may include shows recorded locally on the content receivers 110 and/or shows that are otherwise accessible to the content receivers 110. For example, when one content receiver 110 loses access to a show that the viewer is currently watching, the service provider system 102 may identify another content receiver 110 in a different geographical location that is currently accessing the content for viewing or is able to access the content. Such data collection from the plurality of other content receivers may be performed in advance of any signal loss condition, for example, on an ongoing basis, periodically, or otherwise, or maybe performed responsive to a detection of a signal loss at the content receiver 110. In some embodiments, the service provider system 102 may push a notification to the other content receivers 110 with a pop-up, overlay, etc. with one or more user-selectable interface elements that allow the user of the other content receiver 110 to opt in or opt out of the data collection to facilitate the crowdsourcing. In some embodiments, the service provider system 102 may have previously obtained agreement to the data collection features from users.

The service provider system 102 may coordinate transfer of the content from the other content receiver 110 to the content receiver that has lost access due to signal loss. In some embodiments, a content continuation subsystem 111 of the other content receiver 110 may cause the content to be recorded and transmitted to the content receiver 110 that is experiencing signal loss, while the content continuation subsystem 111 of the content receiver 110 that is experiencing the signal loss may be configured to receive and present the transfer content. In some embodiments, the recording and transferring of the content may take place while the presentation of the content is ongoing. Accordingly, the service provider system 102 may coordinate the conversion of content that is received via satellite at one content receiver 110 into content that is transmitted via the network 120 another content receiver 110. Such coordination may be responsive to a detection of a signal loss at the content receiver 110 that is communicated to the service provider system 102 or may be an anticipation of the signal loss at the content receiver 110.

In some embodiments, the transmission of the content may be peer-to-peer such that the other content receiver 110 of the transmit the content directly to the content receiver 110 experiencing signal loss. In some embodiments, the content may be first transferred to the service provider system 102, then the service provider system 102 may transfer the content to the content receiver 110 experiencing signal loss via the network 120. In some embodiments, the service provider system 102 may push a notification to the other content receiver 110 with a pop-up, overlay, etc. with one or more user-selectable interface elements that allow the user of the other content receiver 110 to opt in or opt out of providing content to other content receivers via crowdsourcing. In some embodiments, the service provider system 102 may have previously obtained agreement to the crowdsourcing features from users.

Additionally or alternatively, in some embodiments, viewership data may be collected, for example, to determine content viewing trends—e.g., what shows are trending now in which geolocations—and the selection of content alternatives 452 may be based at least in part on the viewing trends. In some embodiments, the service provider system 102 may include a viewership data engine that is configured to facilitate identification, aggregation, consolidation, and qualification of viewership data pertinent to a plurality of viewers of content receivers 110 in various geolocations. In embodiments where the content continuation subsystem 111 is included in the service provider system 102, the harvesting engine 430 may be configured with logic to process, analyze, retrieve, pull, cause communication of, derive, compile, aggregate, categorize, characterize, rank, handle, store, report, and/or present any suitable information/content pertaining to viewership—e.g., implicit content ratings derived from histories and patterns of viewing and recording, and explicit content ratings input by viewers. The harvesting engine 430 may be configured to cause viewership information to be transmitted from content receivers 110 to the service provider system 102 for identification, aggregation, consolidation, and qualification of viewership data pertinent to a plurality of viewers of content receivers 110 in various geolocations. In some embodiments, the viewership data engine may correspond to the harvesting engine 430.

In various embodiments, the viewership data and the determination of viewership characteristics may be based at least in part on real-time or near real-time back-channel information from content receivers 110 indicating the channels and/or events being viewed and/or recorded, viewer profiles, viewer selections, viewer geolocations, viewer ratings of events, viewing history, explicit user preferences, user characteristics, and/or the like. Aggregated viewership data may be analyzed to identify a set of one or more viewership characteristics with respect to various shows or other content. Based at least in part on the viewership data, content matching engine 432 and/or the learning engine 434 may differentiate and qualify one or a combination of shows or other content being viewed and/or recorded, viewer profiles, viewer selections, viewer geolocations, viewer ratings of events, viewing history, explicit user preferences, viewer characteristics (e.g., demographics), and/or the like. Some embodiments may employ a decision tree, checklist, workflow, and/or the like to capture various aspects of viewership data and assess those aspects to infer content qualification.

After a viewer has selected one or more content alternatives 452 presented with a content continuation interface 454 over one or more occurrences of signal loss, the subsystem 111 may utilize such selections as feedback. The feedback may be used for training the subsystem 111 to heuristically adapt content alternative 452 recommendations, observation data, profiles, correlations, attributes, patterns, and/or the like to learn particular viewers and improve future content alternative 452 recommendation provisioning to particular viewers. For example, the learning engine 434 may learn that a particular viewer tends to interact with content alternatives 452 that are directed to only certain types of content. Accordingly, the subsystem 111 may bias future content alternatives 452 provisioning toward the types of content that tend to cause viewer selection for viewing and may decrease alternative provisioning frequency or cease provisioning for other types.

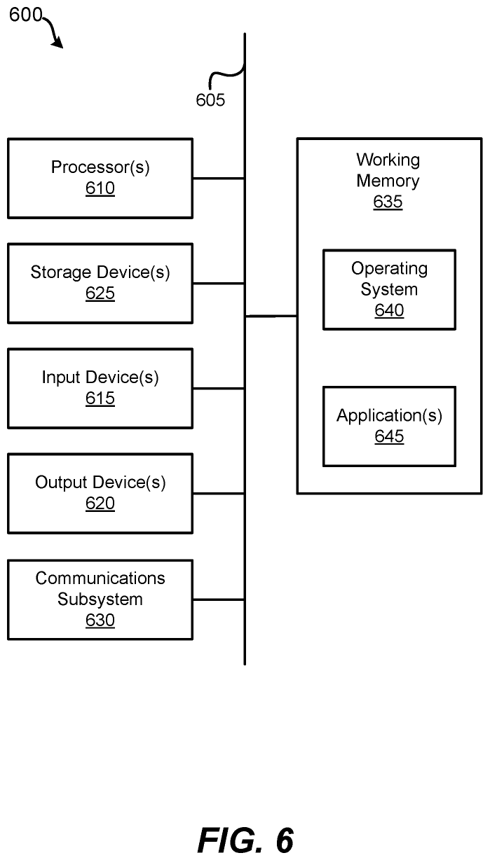

A computer system as illustrated in FIG. 6 may be incorporated as part of the previously described computerized devices, such as a content/television receiver 110 and/or content provider system 102. FIG. 6 provides a schematic illustration of one embodiment of a computer system 600 that can perform various steps of the methods provided by various embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, video decoders, and/or the like); one or more input devices 615, which can include without limitation a mouse, a keyboard, remote control, and/or the like; and one or more output devices 620, which can include without limitation a display device, a printer, and/or the like.

The computer system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device, and/or a chipset (such as a Bluetooth™ device, an 602.11 device, a Wi-Fi device, a WiMAX device, cellular communication device, etc.), and/or the like. The communications subsystem 630 may permit data to be exchanged with a network (such as the network described below, to name one example), other computer systems, and/or any other devices described herein. In many embodiments, the computer system 600 will further comprise a working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure, and/or adapt a general-purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

As mentioned above, in one aspect, some embodiments may employ a computer system (such as the computer system 600) to perform methods in accordance with various embodiments of the invention. According to a set of embodiments, some or all of the procedures of such methods are performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the non-transitory storage device(s) 625. Merely by way of example, execution of the sequences of instructions contained in the working memory 635 might cause the processor(s) 610 to perform one or more procedures of the methods described herein.

The terms “machine-readable medium,” “computer-readable storage medium” and “computer-readable medium,” as used herein in singular or plural form, refer to any medium that participates in providing data that causes a machine to operate in a specific fashion. These mediums may be non-transitory. In an embodiment implemented using the computer system 600, various computer-readable media might be involved in providing instructions/code to processor(s) 610 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 625. Volatile media include, without limitation, dynamic memory, such as the working memory 635.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communications subsystem 630 (and/or components thereof) generally will receive signals, and the bus 605 then might carry the signals (and/or the data, instructions, etc. carried by the signals) to the working memory 635, from which the processor(s) 610 retrieves and executes the instructions. The instructions received by the working memory 635 may optionally be stored on a non-transitory storage device 625 either before or after execution by the processor(s) 610.

It should further be understood that the components of computer system 600 can be distributed across a network. For example, some processing may be performed in one location using a first processor while other processing may be performed by another processor remote from the first processor. Other components of computer system 600 may be similarly distributed. As such, computer system 600 may be interpreted as a distributed computing system that performs processing in multiple locations. In some instances, computer system 600 may be interpreted as a single computing device, such as a distinct laptop, desktop computer, or the like, depending on the context.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium,” “computer-readable storage medium” and “computer-readable medium,” as used herein, refer to any medium that participates in providing data that causes a machine to operate in a specific fashion. These media may be non-transitory. In an embodiment implemented using the computer systems disclosed herein, various computer-readable media might be involved in providing instructions/code to processor(s) for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s). Volatile media include, without limitation, dynamic memory, such as the working memory.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) for execution. Merely by way of example, the instructions may initially be carried on a magnetic disk and/or optical disc of a remote computer. A remote computer might load the instructions into its dynamic memory and send the instructions as signals over a communication medium to be received and/or executed by the computer system. The communications subsystems of computer systems disclosed herein (and/or components thereof) generally will receive signals, and the bus then might carry the signals (and/or the data, instructions, etc. carried by the signals) to the working memory, from which the processor(s) retrieves and executes the instructions. The instructions received by the working memory may optionally be stored on a non-transitory storage device either before or after execution by the processor(s).

It should further be understood that the components of computer systems can be distributed across a network. For example, some processing may be performed in one location using a first processor while other processing may be performed by another processor remote from the first processor. Other components of computer systems may be similarly distributed. As such, the computer systems may be interpreted as a distributed computing system that performs processing in multiple locations. In some instances, computer systems may be interpreted as a single computing device, such as a distinct laptop, desktop computer, or the like, depending on the context.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. A process may correspond to a method, a function, a procedure, a subroutine, a subprogram, etc. Although each may describe the operations as a sequential process, many of the operations can be performed in parallel or concurrently. In addition, the order of the operations may be rearranged. A process may have additional steps not included in the figure. When a process corresponds to a function, its termination my correspond to a return of the function to the calling function or the main function. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

Furthermore, the example embodiments described herein may be implemented as logical operations in a computing device in a networked computing system environment. The logical operations may be implemented as: (i) a sequence of computer implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, the terms in the claims have their plain, ordinary meaning unless otherwise explicitly and clearly defined by the patentee. The indefinite articles “a” or “an,” as used in the claims, are defined herein to mean one or more than one of the element that the particular article introduces; and subsequent use of the definite article “the” is not intended to negate that meaning. Furthermore, the use of ordinal number terms, such as “first,” “second,” etc., to clarify different elements in the claims is not intended to impart a particular position in a series, or any other sequential character or order, to the elements to which the ordinal number terms have been applied.

What is claimed:

1. A system to facilitate continuation of content services in an event of signal loss, the system comprising:
one or more processing devices; and
memory communicatively coupled with, and readable by, the one or more processing devices and having stored therein processor-readable instructions which, when executed by the one or more processing devices, cause the one or more processing devices to perform operations comprising:
detecting a set of one or more electronic communications received via one or more interfaces;
detecting, from the set of one or more electronic communications, an indication of a potential signal loss at a content receiver at a future time;
consequent to the detecting the indication of the potential signal loss, causing the content receiver to configure to respond to a signal loss when the signal loss disrupts causing presentation of content by the content receiver, wherein the content receiver is configured to respond to the signal loss at least in part by causing presentation of one or more user-selectable interface elements corresponding to one or more content alternatives; and
consequent to a selection of at least one user-selectable interface element of the one or more user-selectable interface elements:
the content receiver obtains at least part of at least one of the one or more content alternatives, and
the content receiver outputs for presentation the at least part of the at least one of the one or more content alternatives.

2. The system to facilitate continuation of content services in an event of signal loss as recited in claim 1, wherein the detecting the indication of the potential signal loss is based at least in part on forecasted weather conditions for a location corresponding to the content receiver.

3. The system to facilitate continuation of content services in an event of signal loss as recited in claim 1, wherein the potential signal loss corresponds to a potential loss of a satellite signal at the content receiver.

4. The system to facilitate continuation of content services in an event of signal loss as recited in claim 1, wherein the detecting comprises:
obtaining weather data from the set of one or more electronic communications, and
determining the potential signal loss based at least in part on analyzing the weather data for one or more one or more locations and mapping the one or more locations to the content receiver.

5. The system to facilitate continuation of content services in an event of signal loss as recited in claim 1, wherein the detecting comprises:
obtaining outage data for a plurality of content receivers from the set of one or more electronic communications, and
determining the potential signal loss based at least in part on analyzing the outage data for one or more one or more locations and mapping the one or more locations to the content receiver.

6. The system to facilitate continuation of content services in an event of signal loss as recited in claim 1, the operations further comprising:
processing a set of observation data corresponding to indications of detected receiver operations associated with the content receiver; and
based at least in part on the set of observation data, identifying the one or more content alternatives.

7. The system to facilitate continuation of content services in an event of signal loss as recited in claim 1, the operations further comprising:
processing a set of observation data corresponding to indications of detected receiver operations associated with a plurality of content receivers; and
based at least in part on the set of observation data, identifying the one or more content alternatives.

8. The system to facilitate continuation of content services in an event of signal loss as recited in claim 1, wherein the system comprises the content receiver, and the content receiver comprises the one or more processing devices.

9. The system to facilitate continuation of content services in an event of signal loss as recited in claim 1, wherein the one or more processing devices correspond to a server system that is separate and remote from the content receiver.

10. A method to facilitate continuation of content services in an event of signal loss, the method comprising:
detecting a set of one or more electronic communications received via one or more interfaces;
detecting, from the set of one or more electronic communications, an indication of a potential signal loss at a content receiver at a future time;
consequent to the detecting the indication of the potential signal loss, causing the content receiver to configure to respond to a signal loss when the signal loss disrupts causing presentation of content by the content receiver, wherein the content receiver is configured to respond to the signal loss at least in part by causing presentation of one or more user-selectable interface elements corresponding to one or more content alternatives; and
consequent to a selection of at least one user-selectable interface element of the one or more user-selectable interface elements:
the content receiver obtains at least part of at least one of the one or more content alternatives, and
the content receiver outputs for presentation the at least part of the at least one of the one or more content alternatives.

11. The method to facilitate continuation of content services in an event of signal loss as recited in claim 10, wherein the detecting the indication of the potential signal loss is based at least in part on forecasted weather conditions for a location corresponding to the content receiver.

12. The method to facilitate continuation of content services in an event of signal loss as recited in claim 10, wherein the potential signal loss corresponds to a potential loss of a satellite signal at the content receiver.

13. The method to facilitate continuation of content services in an event of signal loss as recited in claim 10, wherein the detecting comprises:
obtaining weather data from the set of one or more electronic communications, and
determining the potential signal loss based at least in part on analyzing the weather data for one or more one or more locations and mapping the one or more locations to the content receiver.

14. The method to facilitate continuation of content services in an event of signal loss as recited in claim 10, wherein the detecting comprises:
obtaining outage data for a plurality of content receivers from the set of one or more electronic communications, and
determining the potential signal loss based at least in part on analyzing the outage data for one or more one or more locations and mapping the one or more locations to the content receiver.

15. The method to facilitate continuation of content services in an event of signal loss as recited in claim 10, further comprising:
processing a set of observation data corresponding to indications of detected receiver operations associated with the content receiver; and
based at least in part on the set of observation data, identifying the one or more content alternatives.

16. The method to facilitate continuation of content services in an event of signal loss as recited in claim 10, further comprising:
processing a set of observation data corresponding to indications of detected receiver operations associated with a plurality of content receivers; and
based at least in part on the set of observation data, identifying the one or more content alternatives.

17. One or more non-transitory, machine-readable media having machine-readable instructions thereon which, when executed by one or more processing devices, cause the one or more processing devices to perform:
detecting a set of one or more electronic communications received via one or more interfaces;
detecting, from the set of one or more electronic communications, an indication of a potential signal loss at a content receiver at a future time;
consequent to the detecting the indication of the potential signal loss, causing the content receiver to configure to respond to a signal loss when the signal loss disrupts causing presentation of content by the content receiver, wherein the content receiver is configured to respond to the signal loss at least in part by causing presentation of one or more user-selectable interface elements corresponding to one or more content alternatives; and
consequent to a selection of at least one user-selectable interface element of the one or more user-selectable interface elements:
the content receiver obtains at least part of at least one of the one or more content alternatives, and
the content receiver outputs for presentation the at least part of the at least one of the one or more content alternatives.

18. The one or more non-transitory, machine-readable media as recited in claim 17, wherein the detecting the indication of the potential signal loss is based at least in part on forecasted weather conditions for a location corresponding to the content receiver.

19. The one or more non-transitory, machine-readable media as recited in claim 17, wherein the content receiver comprises the one or more processing devices.

20. The one or more non-transitory, machine-readable media as recited in claim 17, wherein the one or more processing devices correspond to a server system that is separate and remote from the content receiver.
